(19) United States
(12) Patent Application Publication
(10) Pub. No.: US 2003/0159047 A1
(43) Pub. Date: Aug. 21, 2003

(54) Method of securing and exposing a logotype in an electronic device

(75) Inventors: Bernard Smeets, Dalby (SE); Bjorn Ekelund, Bjarred (SE); Bernd Moller, Dalby (SE)

Correspondence Address: Ross T. Robinson, Jenkens & Gilchrist, P.C., Suite 3200, 1445 Ross Avenue, Dallas, TX, 75202-2799, US

(73) Assignee: Telefonaktiebolaget L M Ericsson (publ)

(21) Appl. No.: 10/352,297

(22) Filed: Jan. 27, 2003

Related U.S. Application Data
(63) Continuation-in-part of application No. 09/951,676, filed on Sep. 14, 2001.
(60) Provisional application No. 60/412,374, filed on Sep. 20, 2002.
(60) Provisional application No. 60/234,935, filed on Sep. 26, 2000.
(60) Provisional application No. 60/393,604, filed on Jul. 2, 2002.

(51) Int. Cl. H04L 9/00

(52) U.S. Cl. 713/176

(57) ABSTRACT

A logotype to be exposed by an electronic device is secured via a message authentication code or a public key cryptographic scheme. If a message authentication code is used, the message authentication code is re-calculated and compared to a reference message authentication code value during a boot sequence of the electronic device. If the reference message authentication code value and the re-calculated message authentication code value match, further operation of the electronic device is permitted. If the values do not match, the electronic device is disabled from further operation. If a public-key cryptographic scheme is used, the logotype is verified via a public key. If the logotype can be verified, the logotype is exposed.

### RELATED APPLICATIONS

This patent application claims priority from and incorporates by reference the entire disclosure of U.S. Provisional Patent Application No. 60/412,374, which was filed on Sep. 20, 2002. This patent application is a continuation-in-part of and incorporates by reference the entire disclosure of U.S. patent application Ser. No. 09/951,676, filed on Sep. 14, 2001. This patent application claims priority from and incorporates by reference the entire disclosure of U.S. Provisional Patent Application No. 60/234,935, which was filed on Sep. 26, 2000.

### BACKGROUND OF THE INVENTION

1. Technical Field of the Invention

The present invention relates in general to securing information to be exposed to a user of an electronic device and, more particularly, to securing a logotype and a logotype exposure mechanism on an electronic device from being tampered with.

2. Description of Related Art

Many electronic devices include memory for loading code and/or data for use with the electronic devices. A provider of such an electronic devices typically delivers the electronic device with pre-installed code and/or data to a customer who further customizes the electronic device prior to delivering the device to a user.

A logotype is typically defined as a graphical representation or symbol that can be used to identify, for example, a company name, trademark, abbreviation, product, or service. The logotype is often uniquely designed for ready recognition. The logotype is often exposed to the user of the electronic device in connection with a boot sequence of an electronic device. The electronic device can include, for example, a mobile phone or other portable electronic device, and is sometimes referred to as end-user equipment. For purposes of this patent application, the term logotype includes, in addition to the above, any information or data object to be exposed to a user of the electronic device in at least one of an audible, visual, olfactory, gustatory, or tactile manner. Thus, a logotype can also include, for example, a patent notice, an advertisement, or a safety notice.

It is often desirable for marketing or other reasons to be able to expose a logotype in connection with individual components of the end-user equipment, such as electronic platforms, modems, chips, or modules to be included in the end-user equipment. When a provider of an individual component of the end-user equipment wants to have a logotype exposed in connection with the individual component and the provider is not in direct contact with the customer (e.g., through a distributor), it is often to difficult to ensure that the logotype will be exposed as intended by the provider, since it is typically relatively easy for the logotype or a logotype exposure mechanism to be tampered with or otherwise disabled after the individual component has left the control of the provider. Therefore, a method of securing and exposing a logotype in an electronic device that eliminates the drawbacks mentioned above and other drawbacks is needed.

### SUMMARY OF THE INVENTION

These and other drawbacks are overcome by embodiments of the present invention, which provides a method of securing and exposing a logotype in an electronic device. In an embodiment of the present invention, a method of securing a logotype includes storing data relative to the logotype to an electronic device, storing code to the electronic device, and protecting at least the data relative to the logotype via a message authentication code (MAC). The code is adapted to use the data relative to the logotype to expose the logotype.

In another embodiment of the present invention, a method of accessing a secure logotype includes re-calculating, in connection with a boot sequence of an electronic device, of a MAC value, thereby yielding a re-calculated MAC value. The method also includes comparing a reference MAC value to the re-calculated MAC value. If the step of comparing results in a match between the reference MAC value and the re-calculated MAC value, a first operation is performed. If the step of comparing does not result in a match between the reference MAC value and the re-calculated MAC value, a second operation is performed.

In another embodiment of the present invention, a method of securing a logotype includes storing data relative to the logotype, storing code externally to a first chip of an electronic device, and storing, to the first chip of the electronic device, a public key relative to the code and the data relative to the logotype. The code is adapted to use the data relative to the logotype to expose the logotype. The public key is adapted to protect the code and the data relative to the logotype.

In another embodiment of the present invention, a method of accessing a secure logotype includes loading code adapted to use data relative to the logotype onto a first chip of an electronic device and verifying, via a public key, of authenticity of the loaded externally-stored code and the data relative to the logotype. In response to the authenticity being verified, the logotype is exposed.

In another embodiment of the present invention, an apparatus for securing a logotype includes means for storing data relative to the logotype to an electronic device, means for storing code to the electronic device, and means for protecting at least the data relative to the logotype via a message authentication code (MAC). The code is adapted to use the data relative to the logotype to expose the logotype.

In another embodiment of the present invention, an apparatus for accessing a secure logotype includes means for re-calculating, in connection with a boot sequence of an electronic device, of a MAC value. The re-calculation thereby yields a re-calculated MAC value. The apparatus also includes means for comparing a reference MAC value to the re-calculated MAC value, means for performing a first operation in response to a comparison resulting in a match between the reference MAC value and the re-calculated MAC value, and means for performing a second operation in response to a comparison not resulting in a match between the reference MAC value and the recalculated MAC value.

In another embodiment of the present invention, an apparatus for securing a logotype includes means for storing data relative to the logotype, means for storing code externally to a first chip of an electronic device, and means for storing, to the first chip of the electronic device, a public key relative to the code and the data relative to the logotype. The code is adapted to use the data relative to the logotype to expose the logotype. The public key is adapted to protect the code and the data relative to the logotype.

In another embodiment of the present invention, an apparatus for accessing a secure logotype includes means for loading code adapted to use data relative to the logotype onto a first chip of an electronic device, means for verifying, via a public key, of the loaded externally-stored code and the data relative to the logotype, and means for exposing the logotype in response to verification of the loaded externally-stored code.

### BRIEF DESCRIPTION OF THE DRAWINGS

A more complete understanding of exemplary embodiments of the present invention can be achieved by reference to the following Detailed Description of Exemplary Embodiments of the Invention when taken in conjunction with the accompanying Drawings, wherein:

FIG. 1 is a block diagram of an exemplary electronic device 100 in accordance with principles of the present invention;

FIG. 2 is a flow diagram that illustrates securing of a logotype on an electronic device via a message authentication code in accordance with principles of the present invention;

FIG. 3 is a diagram of a flow 300 that illustrates exposure of a logotype on an electronic device using a message authentication code (MAC) in accordance with principles of the present invention;

FIG. 4 is a diagram of a flow 400 that illustrates securing of a logotype on an electronic device via a digital signature using a public-key cryptographic scheme in accordance with principles of the present invention; and

FIG. 5 is a diagram of a flow 500 that illustrates exposure of a logotype on an electronic device via a digital signature in accordance with principles of the present invention; and

FIG. 6 is a diagram of a flow 600 that illustrates a logotype post-exposure verification process in accordance with principles of the present invention.

### DETAILED DESCRIPTION OF EXEMPLARY EMBODIMENTS OF THE INVENTION

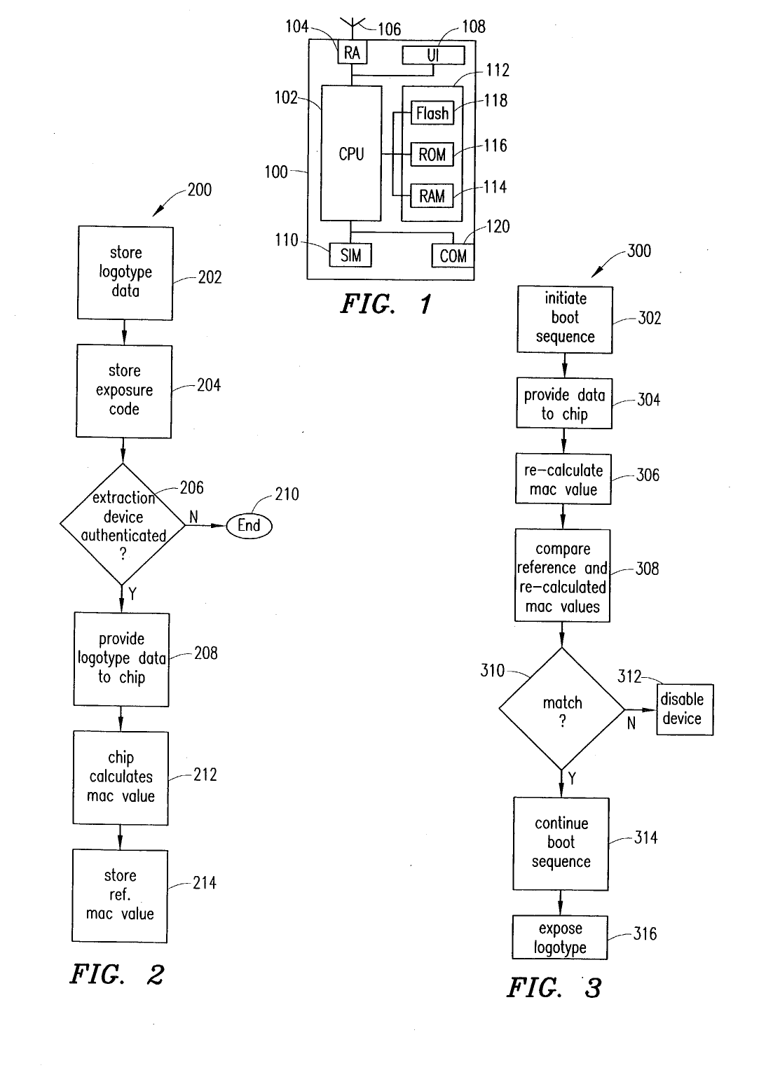

FIG. 1 is a block diagram of an exemplary electronic device 100 in accordance with principles of the present invention. The electronic device 100 includes a processing unit 102 for controlling functions of the electronic device 100. The electronic device 100 also includes a radio interface 104 with an aerial interface 106 for transmitting and receiving data to and from a wireless communications network (not shown), such as, for example, a cellular network. The electronic device 100 also includes a user interface 108, which can be, for example, a display, a keypad or other input means, or the like. The electronic device 100 can also include a subscriber identity module (SIM) 110 that includes memory for storing subscriber identity information, at least one telephone number, and other data related to a user's subscription with a network operator.

The electronic device 100 further includes a storage medium 112. The storage medium 112 can include a random-access memory (RAM) section 114, a read-only memory (ROM) section 116, and a flash-memory section 118. The storage medium 112 of the electronic device 100 can also include other types of memory, such as erasable programmable (EPROM), electrically-erasable programmable ROM (EEPROM), or the like, or other types of storage media, such as optical disc, digital video disk (DVD), compact disc (CD or CD-ROM), mini-disc, hard disk, ferromagnetic memory, optical storage, charge coupled devices, PCMCIA cards, or the like.

The electronic device 100 also includes a communications unit 120, which can be, for example, a BLUETOOTH transceiver, an IrDa port, a USB adapter, a cable connector, or the like. The radio interface 104 can be used to receive data over the air via the wireless communication network. The electronic device 100 can be any kind of end-user equipment, such as, for example, portable radio communication equipment, wherein the term portable radio communication equipment includes, for example, mobile telephones, pagers, communicators, electronic organizers, smart phones, personal digital assistants, handheld computers, or the like.

A relatively straight-forward solution to securing a logotype from being tampered with is to store data relative to the logotype and code used to expose the logotype in one-time-programmable (OTP) memory on a chip from a provider (not explicitly shown in FIG. 1) that is to be used in the electronic device 100. OTP memory includes, for example, the ROM section 116. The logotype and the code used to expose the logotype can be stored in, for example, read-only memory (ROM) code. Once the OTP memory has been put into a read-only state, the logotype is protected from tampering; however, this solution requires advance knowledge of, for example, display capabilities, etc. of the electronic device. Because different electronic devices have varying features and capabilities, the OTP memory to be used in the different electronic devices would need to have different code stored thereon, which code variations would tend to increase production costs.

In another embodiment of the invention, data relative to the logotype (i.e., the logotype data), and potentially all or part of the code used to expose the logotype (i.e., the exposure code) can be stored externally to the chip from the provider. In another, the logotype data is stored on the chip and all or part of the exposure code is stored externally to the chip in, for example, the flash memory section 118, the ROM section 116, or the RAM section 114. Such external storage of the logotype data and/or all or part of the exposure code permits easier logotype-exposure adaptation to, for example, variations in graphic displays used by certain electronic devices. However, when the logotype data and all or part of the exposure code are stored externally to the chip, a way to protect the logotype against tampering is needed.

FIG. 2 is a diagram of a flow 200 that illustrates securing of a logotype on an electronic device via a message authentication code (MAC) in accordance with principles of the present invention. In embodiments of the invention, the logotype data and potentially all or part of the exposure code are protected by a reference MAC value that is stored on the chip. A reference MAC value that results from a cryptographic MAC computation of the logotype data using a hidden key parameter stored on the chip is calculated. Several MAC computation algorithms are known and are suitable for use. The HMAC algorithm using the sha-1 secure hash algorithm is an example. If the reference MAC value stored on the chip does not equal a re-calculated MAC value calculated by the electronic device during, for example, a boot sequence of the electronic device, the boot sequence can be interrupted and the electronic device powered off or operation of the electronic device disabled in some other way. U.S. Pat. No. 6,026,293 to Osborn, which discloses a system for preventing electronic memory tampering, is incorporated by reference herein.

Referring again to FIG. 2, the flow 200 begins at step 202. At step 202, the logotype data is stored on the electronic device. The logotype data can be stored on the chip itself or can be stored externally to the chip. At step 204, the exposure code is stored. The exposure code can be stored on the chip itself or all or part of the exposure code can be stored externally to the chip.

At step 206, in response to an attempt by an extraction device to authenticate itself to the chip, a determination is made whether the extraction device has successfully authenticated itself to the chip. The authentication procedure represented by step 206 serves to protect against unauthorized extraction of the reference MAC value from the chip. In embodiments of the invention, step 206 includes the chip challenging the extraction device to prove that the extraction device is authorized to extract the reference MAC value calculated by the chip. If authentication is determined to have been successful, execution proceeds to step 208. At step 208, the logotype data stored at step 202 is provided to the chip. If authentication is determined, at step 206, to have been unsuccessful, execution ends at step 210. At step 212, the chip calculates a MAC value based on the logotype data and potentially all or part of the exposure code. The MAC value calculated at step 212 is referred to as the reference MAC value. At step 214, the reference MAC value calculated at step 212 is stored on the chip.

The ability of entities outside the chip to get access to the reference MAC value from the chip can be protected against as illustrated in FIG. 2. If subsequent unauthorized extraction of the reference MAC value calculated at step 212 and stored on the chip at step 214 is not protected against, modification or removal of the logotype to be exposed could easily be performed. For example, the chip could be caused by an unauthorized user to calculate the MAC value and then the calculated reference MAC value could be taken from the chip. During a later instance, when the unauthorized user desires to present a different logotype (or no logotype at all), the unauthorized user could merely present the reference MAC value that had been calculated and extracted from the chip.

In order avoid this problem, the procedure illustrated in FIG. 2 makes extraction of the calculated reference MAC from the chip conditional upon an authentication procedure. Evidence must be presented to the chip that the logotype data or the exposure code that are to be used by the electronic device are correct and match to the chip. In order to get the evidence (i.e., the reference MAC value) from the chip, authentication to the chip must be achieved. The unauthorized user that wants to modify or remove the logotype intended by the provider to be exposed will not be able to get the reference MAC value from the chip, because the chip will not make the reference MAC value available to the unauthorized user.

FIG. 3 is a diagram of a flow 300 that illustrates exposure of a logotype on an electronic device using a message authentication code (MAC) in accordance with principles of the present invention. In embodiments of the invention, under normal operational conditions of the electronic device, such as, for example, during a boot sequence of the electronic device, when the electronic device seeks to use the chip from the provider, the electronic device must present predetermined data to the chip. For example, if the logotype data was used by the chip to calculate the reference MAC value as illustrated in FIG. 2, the logotype data must be presented to the chip as part of the boot sequence of the electronic device. If, instead, the logotype data and all or part of the exposure code were used by the chip as illustrated in FIG. 2 to calculate the reference MAC value, the same data and code must be presented to the chip for the electronic device to gain access to the chip during normal operational conditions. In response to receipt of the data previously used to calculate the reference MAC value, the chip re-calculates the MAC value and performs a comparison between the reference MAC value and the re-calculated MAC value. If these two values do not match, the chip will not provide full functionality to the electronic device. If the reference MAC value and the-calculated MAC value do match, then full functionality of the chip is provided to the electronic device.

Referring again to FIG. 3, the flow 300 begins at step 302, at which step a boot sequence of the electronic device is initiated. At step 304, the data used to calculate the reference MAC value at, for example, step 212, is provided to the chip. As noted above, the data provided at step 304 can be the logotype data or the logotype data and all or part of the exposure code. Other data can also be used for calculation of the MAC value as step 212 and provided to the chip at step 304 as desired by the provider. From step 304, execution proceeds to step 306. At step 306, the chip re-calculates the MAC value based upon the data provided at step 304. At step 308, the re-calculated MAC value and the reference MAC value previously stored on the chip at, for example, step 214, are compared to one another.

At step 310, a determination is made whether the re-calculated MAC value and the reference MAC value match one another. If it is determined at 310 that the re-calculated MAC value and the reference MAC value do not match one another, the electronic device is disabled at step 312. If, however, at step 310, it is determined that re-calculated MAC value and the reference MAC value do match one another, at step 314, the boot sequence is continued. At step 316, the exposure code is used to expose the logotype and the device is permitted full functional access to the chip.

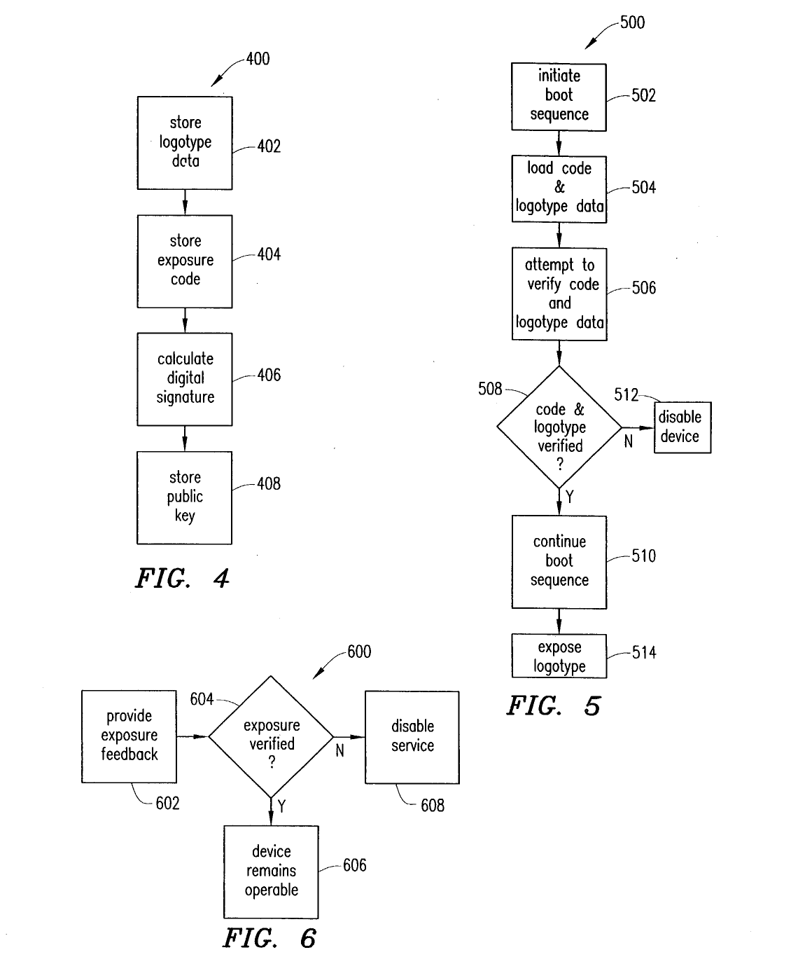

FIG. 4 is a diagram of a flow 400 that illustrates securing of a logotype on an electronic device via a digital signature using a public-key cryptographic scheme in accordance with principles of the present invention. In another embodiment of the present invention, in order to avoid the need for a MAC extraction device, the MAC can be replaced by a digital signature that uses a public-key cryptographic scheme. In embodiments of the present invention, the digital signature covers the exposure code and the logotype data. During a boot sequence of the electronic device, the exposure code is loaded onto the chip. The logotype data can be loaded onto the chip during the boot sequence or can be stored on the chip itself The exposure code and the logotype data can be verified using a public key stored in non-volatile on-chip memory. The digital signature is calculated a single time in a secure environment that protects a private key used in a signing process.

Within the field of cryptography, use of combined public and private keys is referred to as public-key or asymmetric cryptography. A system for using public keys is called a public key infrastructure (PKI). The very nature of public-key cryptography permits use of digital signatures. A sender can publish a decryption key (i.e. the public key) and keep a corresponding encryption key (i.e., the private key) secret. When the sender encrypts a message (or a value derived from the message), anyone can decrypt the message using the public decrypting key. In so doing, a recipient can use the public decrypting key to ensure that the message could only have been encrypted by the sender, since the sender is the sole possessor of the encryption key. Hence, the sender has effectively “signed” the message.

Referring again to FIG. 4, the flow 400 begins at step 402, at which step the logotype data is stored onto the device. As mentioned above, the logotype data can be stored externally to the chip or can be stored on the chip itself At step 404, the exposure code is stored. At step 406, a digital signature to be used for signing the logotype data and/or the exposure code is calculated in a secure environment. The digital signature protects a private key used in the signing process. At step 408, a public key is stored to the chip.

FIG. 5 is a diagram of a flow 500 that illustrates exposing of a logotype on an electronic device via a digital signature in accordance with principles of the present invention. In embodiments of the present invention, during a boot sequence of the electronic device, the exposure code is loaded onto the chip. The logotype data can be loaded onto the chip during the boot sequence or can be stored on the chip itself During the boot sequence, the exposure code and the logotype are verified using a public key stored in non-volatile on-chip memory.

Referring again to FIG. 5, the flow 500 begins at step 502, at which step the boot sequence is initiated. At step 504, the exposure code and optionally the logotype data are loaded onto the chip from the provider. As noted above, the logotype data can either stored on the chip itself or can be loaded onto the chip during the boot sequence. At step 506, the chip attempts to verify the code and the logotype data using a digital signature, such as the digital signature calculated at step 406. At step 508, a determination is made whether the exposure code and the logotype data have been verified via the digital signature. If, at step 508, it is determined that the exposure code and the logotype data have been verified, execution proceeds to step 510. At step 510, the boot sequence is continued. If, however, at step 508, it is determined that the exposure code and the logotype data have not been verified, execution proceeds to step 512. At step 512, the device is disabled from further operation. From step 510, execution proceeds to step 514, at which step the logotype is exposed.

In another embodiment of the invention, the logotype data may be remotely stored outside the electronic device. Code that is stored on the electronic device and externally to the chip is used to locate any logotype data that may be remotely stored in/or digitally signed, verify authenticity of the located logotype data, and start the exposure code. For example, detection code could include code that performs access to a wireless communications network. With a remotely-located logotype, even if the electronic device cannot be brought to full functionality, the wireless communications network can securely obtain information about the electronic device, such as version, make, or relevant code of the electronic device.

FIG. 6 is a diagram of a flow 600 that illustrates a logotype post-exposure verification process in accordance with principles of the present invention. In order to further protect against disabling of logotype-exposure hardware or software during the time that the exposure code uses the logotype data, a feedback channel can be used to permit the exposure code to verify that the logotype has been exposed. For example, a graphics-unit memory can be read back or analog signal from a speaker of the electronic device can be measured and digitally sampled back to the chip and verified with the logotype data that should have been exposed.

Referring to again to FIG. 6, the flow 600 begins at step 602, at which step exposure feedback is provided to the chip. At step 604, the chip verifies that the exposure feedback received matches exposure indicia that is expected and that was previously stored on the chip. If, at step 604, exposure is verified, execution proceeds to step 606, at which step the device remains operable. If, however, at step 604, exposure is not verified, execution proceeds to step 608. At step 608, the device is disabled.

Although embodiment(s) of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the invention defined by the following claims.

What is claimed is:

1. A method of securing a logotype, the method comprising:
storing data relative to the logotype to an electronic device;
storing code to the electronic device, the code being adapted to use the data relative to the logotype to expose the logotype; and
protecting at least the data relative to the logotype via a message authentication code (MAC).

2. The method of claim 1, wherein at least a portion of the code is stored to a first chip of the electronic device and the data relative to the logotype is stored to a second chip of the electronic device.

3. The method of claim 2, the step of protecting further comprising:
calculating a reference MAC value; and
storing the calculated reference MAC value on the first chip.

4. The method of claim 3, wherein the reference MAC value is calculated based on the data relative to the logotype.

5. The method of claim 1, wherein at least a portion of the code is stored other than to a first chip of the electronic device and the data relative to the logotype is stored to a second chip of the electronic device.

6. The method of claim 5, the step of protecting comprising protecting the portion of the code stored other than to the first chip and the data relative to the logotype via the message authentication code (MAC).

7. The method of claim 6, the step of protecting comprising:
calculating a reference MAC value; and
storing the calculated reference MAC value on the first chip.

8. The method of claim 7, wherein the reference MAC value is calculated based on the code stored to other than the first chip and the data relative to the logotype stored to the second chip.

9. A method of accessing a secure logotype, the method comprising:
re-calculating, in connection with a boot sequence of an electronic device, of a MAC value, thereby yielding a re-calculated MAC value;
comparing a reference MAC value to the re-calculated MAC value;
if the step of comparing results in a match between the reference MAC value and the recalculated MAC value, performing a first operation; and
if the step of comparing does not result in a match between the reference MAC value and the re-calculated MAC value, performing a second operation.

10. The method of claim 9, wherein the first operation comprises permitting further operation of the electronic device.

11. The method of claim 9, wherein the second operation comprises disabling at least one function of the electronic device.

12. The method of claim 10, wherein the first operation comprises exposing the logotype.

13. The method of claim 10, wherein the first operation comprises:
loading code for exposing the logotype for execution by the electronic device; and
exposing the logotype.

14. The method of claim 12, further comprising performing a post-exposure verification procedure.

15. A method of securing a logotype, the method comprising:
storing data relative to the logotype;
storing code externally to a first chip of an electronic device, the code being adapted to use the data relative to the logotype to expose the logotype;
storing, to the first chip of the electronic device, a public key relative to the code and the data relative to the logotype, the public key being adapted to protect the code and the data relative to the logotype.

16. The method of claim 15, further comprising calculating a digital signature relative to the code and the data relative to the logotype.

17. The method of claim 15, wherein the data relative to the logotype is stored to the first chip.

18. A method of accessing a secure logotype, the method comprising:
loading code adapted to use data relative to the logotype onto a first chip of an electronic device;
verifying, via a public key, of authenticity of the loaded externally-stored code and the data relative to the logotype; and
in response to the authenticity being verified, exposing the logotype.

19. The method of claim 18, wherein the steps of loading and verifying are performed in connection with a boot sequence of the electronic device.

20. The method of claim 18, further comprising loading the data relative to the logotype onto the first chip.

21. The method of claim 18, wherein the data relative to the logotype is stored externally to the electronic device, the method further comprising accessing the data relative to the logotype via a wireless communications network.

22. The method of claim 18, further comprising performing a post-exposure verification procedure.

23. An apparatus for securing a logotype, the apparatus comprising:
means for storing data relative to the logotype to an electronic device;
means for storing code to the electronic device, the code being adapted to use the data relative to the logotype to expose the logotype; and
means for protecting at least the data relative to the logotype via a message authentication code (MAC).

24. The apparatus of claim 23, wherein at least a portion of the code is stored to a first chip of the electronic device and the data relative to the logotype is stored to a second chip of the electronic device.

25. The apparatus of claim 24, the step of protecting further comprising:
means for calculating a reference MAC value; and
means for storing the calculated reference MAC value on the first chip.

26. The apparatus of claim 25, wherein the reference MAC value is calculated based on the data relative to the logotype.

27. The apparatus of claim 23, wherein at least a portion of the code is stored other than to a first chip of the electronic device and the data relative to the logotype is stored to a second chip of the electronic device.

28. The apparatus of claim 27, the means for protecting comprising means for protecting the portion of the code stored other than to the first chip and the data relative to the logotype via the message authentication code (MAC).

29. The apparatus of claim 28, the means for protecting comprising:
means for calculating a reference MAC value; and
means for storing the calculated reference MAC value on the first chip.

30. The apparatus of claim 29, wherein the reference MAC value is calculated based on the code stored to other than the first chip and the data relative to the logotype stored to the second chip.

31. An apparatus for accessing a secure logotype, the apparatus comprising:
means for re-calculating, in connection with a boot sequence of an electronic device, of a MAC value, thereby yielding a re-calculated MAC value; and
means for comparing a reference MAC value to the re-calculated MAC value;
means for performing a first operation in response to a comparison resulting in a match between the reference MAC value and the re-calculated MAC value; and
means for performing a second operation in response to a comparison not resulting in a match between the reference MAC value and the re-calculated MAC value.

32. The apparatus of claim 31, wherein the means for performing the first operation comprises means for permitting further operation of the electronic device.

33. The apparatus of claim 31, wherein the means for performing the second operation comprises means for disabling at least one function of the electronic device.

34. The apparatus of claim 32, wherein the means for performing the first operation comprises means for exposing the logotype.

35. The apparatus of claim 32, wherein the means for performing the first operation comprises:
means for loading code for exposing the logotype for execution by the electronic device; and
means for exposing the logotype.

36. The apparatus of claim 34, further comprising means for performing a post-exposure verification procedure.

37. An apparatus for securing a logotype, the apparatus comprising:
means for storing data relative to the logotype;
means for storing code externally to a first chip of an electronic device, the code being adapted to use the data relative to the logotype to expose the logotype;
means for storing, to the first chip of the electronic device, a public key relative to the code and the data relative to the logotype, the public key being adapted to protect the code and the data relative to the logotype.

38. The apparatus of claim 37, further comprising means for calculating a digital signature relative to the code and the data relative to the logotype.

39. The apparatus of claim 37, wherein the data relative to the logotype is stored to the first chip.

40. An apparatus for accessing a secure logotype, the apparatus comprising:
means for loading code adapted to use data relative to the logotype onto a first chip of an electronic device;
means for verifying, via a public key, of the loaded externally-stored code and the data relative to the logotype; and
means for exposing the logotype in response to verification of the loaded externally-stored code.

41. The apparatus of claim 40, wherein the means for loading and the means for verifying are adapted to operate in connection with a boot sequence of the electronic device.

42. The apparatus of claim 40, further comprising means for loading the data relative to the logotype onto the first chip.

43. The apparatus of claim 42, wherein the data relative to the logotype is stored externally to the electronic device, the apparatus further comprising means for accessing the data relative to the logotype via a wireless communications network.

44. The apparatus of claim 40, further comprising means for performing a post-exposure verification procedure.
